(19) United States
(12) Patent Application Publication
(10) Pub. No.: US 2018/0051169 A1
(43) Pub. Date: Feb. 22, 2018

(54) RESIN COMPOSITION AND METHOD OF PRODUCING THE SAME

(71) Applicant: CANON KABUSHIKI KAISHA, Tokyo (JP)

(72) Inventors: Takeshi Komuro, Matsudo-shi (JP); Atsushi Fuseya, Yokohama-shi (JP)

(21) Appl. No.: 15/554,321

(22) PCT Filed: Mar. 30, 2016
(86) PCT No.: PCT/JP2016/061183

§ 371 Date: Aug. 29, 2017

(30) Foreign Application Priority Data
Apr. 27, 2015 (JP) 2015-090475

(51) Int. Cl. B32B 9/04; C08L 69/00; C08J 3/20; C08J 3/22; B29B 7/48; B29C 45/00; B29C 47/00; B29B 9/06; B29B 13/06

(52) U.S. Cl. CPC C08L 69/00; C08J 3/203; C08J 3/22; B29B 7/48; B29C 45/0001; B29C 47/0004; B29K 2069/00; B29B 9/06; B29B 13/065; C08L 2201/02; C08J 2369/00; C08J 2467/04; C08J 2451/08; G03G 21/1619

(57) ABSTRACT

Provided is a resin composition, including: a polycarbonate resin; a biomass resin having a hydroxy group; a rubber having a siloxane bond and having a functional group reactive with a hydroxy group; a flame retardant; and a drip preventing agent, in which: when a total of all the components is defined as 100 mass %, contents of the components are: biomass resin having a hydroxy group: 5 mass % or more to 25 mass % or less, the rubber having a siloxane bond and having a functional group reactive with a hydroxy group: 1 mass % or more to 9 mass % or less, the flame retardant: 3 mass % or more to 20 mass % or less, and the drip preventing agent: 0.1 mass % or more to 5 mass % or less; and a mass ratio of the biomass resin having a hydroxy group to the polycarbonate resin is 0.35 or less.

### TECHNICAL FIELD

The present invention relates to a resin composition and a method of producing the same.

### BACKGROUND ART

In recent years, for the purpose of reducing amounts of carbon dioxide emissions and usage amounts of fossil resources, environmentally friendly materials have been developed actively. With regard to the environmentally friendly materials, there have been proposed, for example, a method involving regenerating and reutilizing a resin recovered from the market (PTL 1) and a method involving using, as part of materials, a biomass-derived resin produced from a bio-renewable raw material (PTL 2). In addition, as a further environmentally friendly material, there has been proposed a resin material using both the biomass-derived resin and a regenerated resin recovered from the market (PTL 3). Specifically, in PTL 2, there has been proposed a resin composition which contains a polylactic acid resin, a polycarbonate resin, a phosphazene-based flame retardant, and a fluorine-containing drip preventing agent, and thus has imparted thereto impact strength and flame retardancy. In addition, in PTL 3, there has been proposed a resin composition which utilizes a polylactic acid resin, and a polycarbonate resin containing a regenerated resin recovered from an optical disc, and is excellent in impact strength and surface appearance.

However, the resin composition of PTL 2 needs to be molded at a high mold temperature of 100° C. or more so that polylactic acid is crystallized. Therefore, the resin composition has problems of a long molding cycle and a large dimensional change as compared to the case of using such resin composition in an amorphous state through molding at a low mold temperature of less than 100° C. In addition, with regard to the resin composition of PTL 3, flame retardancy is not imparted, and hence high flame retardancy (V-1 or more of UL-94 standard) required for applications as an internal part of an electrical and electronic device and the like cannot be obtained.

As shown in PTLs 2 and 3, it is difficult for the related-art environmentally friendly materials each utilizing a polycarbonate resin and a biomass-derived resin to satisfy good productivity, high flame retardancy and impact strength with which each material can withstand practical use as an internal part of an electrical and electronic device and the like, and excellent surface appearance at the same time.

### CITATION LIST

### Patent Literature

PTL 1: Japanese Patent No. 5279966

PTL 2: Japanese Patent Application Laid-Open No. 2011-246646

PTL 3: Japanese Patent Application Laid-Open No. 2007-321096

### SUMMARY OF INVENTION

### Technical Problem

Thus, an object of the present invention is to provide a resin composition having high flame retardancy and impact strength, and excellent surface appearance while containing a polycarbonate resin and a biomass resin.

### Solution to Problem

A resin composition according to one embodiment of the present invention includes:

(A) a polycarbonate resin;

(B) a biomass resin having a hydroxy group;

(C) a rubber having a siloxane bond and having a functional group reactive with a hydroxy group;

(D) a flame retardant; and

(E) a drip preventing agent,

in which:

when a total of all the components of (A) to (E) is defined as 100 mass %, contents of the components are:

the (B) biomass resin having a hydroxy group: 5 mass % or more to 25 mass % or less,

the (C) rubber having a siloxane bond and having a functional group reactive with a hydroxy group: 1 mass % or more to 9 mass % or less,

the (D) flame retardant: 3 mass % or more to 20 mass % or less, and

the (E) drip preventing agent: 0.1 mass % or more to 5 mass % or less; and

a mass ratio of the biomass resin having a hydroxy group to the polycarbonate resin is 0.35 or less.

In addition, a method of producing a resin composition according to one embodiment of the present invention is a method of producing the resin composition according to the above-mentioned embodiment of the present invention, the method including:

a first step of melt-kneading the polycarbonate resin and at least part of the flame retardant; and

a second step of melt-kneading: a kneaded product obtained in the first step, the biomass resin having a hydroxy group, and the rubber having a siloxane bond and having a functional group reactive with a hydroxy group; or the kneaded product obtained in the first step, the biomass resin having a hydroxy group, the rubber having a siloxane bond and having a functional group reactive with a hydroxy group; and a rest of the flame retardant.

Further features of the present invention will become apparent from the following description of exemplary embodiments with reference to the attached drawings.

### BRIEF DESCRIPTION OF DRAWINGS

FIG. 1A is a view for illustrating an example of an image forming apparatus and is an illustration of only external materials.

FIG. 1B is a view for illustrating the example of the image forming apparatus and is an illustration including also quasi-external materials.

### DESCRIPTION OF EMBODIMENTS

Preferred embodiments of the present invention will now be described in detail in accordance with the accompanying drawings.

<(A) Polycarbonate Resin>

A component (A) is a resin containing, in its polymer main chain, a carbonate ester of a dihydric phenol. As the component (A), it is preferred to use a resin which allows a resin composition to be obtained to have a weight-average molecular weight of 30,000 or more in terms of polystyrene measured by size exclusion chromatography. The weight-average molecular weight of the resin composition may be measured by size exclusion chromatography with a UV detector at 254 nm. One kind of the component (A) may be used alone, or two or more kinds thereof may be used in combination. It is noted that the size exclusion chromatography is also called gel permeation chromatography.

The component (A) is preferably a regenerated polycarbonate resin containing a polycarbonate resin recovered from the market. The content of the polycarbonate resin recovered from the market in the regenerated polycarbonate resin is not particularly limited. The regenerated polycarbonate resin is obtained from a pulverized product of a recovered molded product containing a polycarbonate resin. Examples of the recovered molded product include various bottles, and a housing and a mechanism part which serve as constituent parts of an electrical appliance, an information device, an automobile, or the like. Such molded products are adopted by being recovered from the market after their utilization for a certain period of time. As the regenerated polycarbonate resin, a pulverized product obtained by pulverizing the recovered molded product and subjecting the resultant to classification treatment is used. A pulverized product obtained from one kind of molded product may be used alone, or pulverized products obtained from two or more kinds of molded products may be used in combination. The dimensions of the pulverized product subjected to the classification treatment are not limited as long as the pulverized product can be kneaded with a kneader, but the pulverized product preferably has an average particle diameter of 10 mm or less particularly in view of ease of its feed to the kneader.

The regenerated polycarbonate resin has a weight-average molecular weight of preferably 30,000 or more, more preferably 35,000 or more in terms of polystyrene measured by size exclusion chromatography. When the weight-average molecular weight is 30,000 or more, sufficient impact strength can be obtained. The weight-average molecular weight of the regenerated polycarbonate resin may be measured by size exclusion chromatography with a UV detector at 254 nm.

<(B) Biomass Resin Having Hydroxy Group>

A component (B) is a resin in which at least part of the resin or its raw material is produced from a plant. For example, the resin or its raw material may be obtained through extraction or chemical synthesis from a plant raw material. Specific examples of the component (B) include polylactic acid, polybutylene succinate, polyethylene terephthalate, polyacetal, cellulose acetate, and cellulose propionate. Of those, polylactic acid is preferred. One kind of the component (B) may be used alone, or two or more kinds thereof may be used in combination.

The content of the component (B) is 5 mass % or more to 25 mass % or less, preferably 15 mass % or more to 25 mass % or less when the total of the components (A) to (E) is defined as 100 mass %. When the content of the component (B) is 5 mass % or more, an effect of reducing the amounts of carbon dioxide emissions and the usage amounts of fossil resources can be obtained. When the content of the component (B) is 25 mass % or less, impact strength and flame retardancy can be obtained.

Further, the mass ratio (B)/(A) of the component (B) to the component (A) is 0.35 or less. When the mass ratio (B)/(A) is 0.35 or less, sufficient impact strength and flame retardancy can be obtained.

<(C) Rubber Having Siloxane Bond and Having Functional Group Reactive with Hydroxy Group>

A component (C) is a rubber having, in its polymer structure, a siloxane bond and a functional group reactive with a hydroxy group. The functional group reactive with a hydroxy group in the component (C) preferably reacts with a hydroxy group in the component (B). The reaction rate of the functional group reactive with a hydroxy group is not particularly limited, but is preferably 1% or more, more preferably 5% or more. When the reaction rate of the functional group reactive with a hydroxy group is 1% or more, affinity between the resin and the rubber is enhanced, and sufficient impact strength and flame retardancy can be obtained. The reaction rate of the functional group reactive with a hydroxy group may be confirmed by NMR. For example, the reaction rate may be confirmed by the fact that a peak of a hydroxy group confirmed before a reaction is reduced in height after the reaction.

Examples of the functional group reactive with a hydroxy group include a three to six-membered ring hydrocarbon group having an oxygen atom in its ring structure, an isocyanate group, a carboxy group, and a hydroxy group. The three to six-membered ring hydrocarbon group having an oxygen atom in its ring structure is preferably a three or four-membered ring group, particularly preferably a three-membered ring group. Specifically, a glycidyl group is suitable. In addition, it is preferred that the component (C) have high affinity for the resin. In particular, a rubber having a core-shell structure is preferred. The “rubber having a core-shell structure” refers to a rubber including a core part and a shell part, the core part including a rubber layer configured to relax a stress and increase strength, the shell part including a layer having high affinity for the resin. For example, there is given a form including as its core part a silicone/acrylic composite rubber and as its shell part a graft layer of a vinyl-based polymer. An example thereof is “Metablen S-2200” manufactured by Mitsubishi Rayon Co., Ltd.

The content of the component (C) is 1 mass % or more to 9 mass % or less, preferably 2 mass % or more to 7 mass % or less when the total of the components (A) to (E) is defined as 100 mass %. When the content of the component (C) is 1 mass % or more, the impact strength and flame retardancy can be obtained. When the content of the component (C) is 9 mass % or less, heat resistance and the flame retardancy can be obtained.

<(D) Flame Retardant>

As a component (D), an organic flame retardant, an inorganic flame retardant, or a combination thereof may be used. A phosphorus-based flame retardant is preferred. Specific examples thereof include: phosphates such as triphenyl phosphate, tricresyl phosphate and trixylyl phosphate; and condensed phosphates such as resorcinol bis(diphenyl phosphate), bisphenol A bis(diphenyl phosphate) and resorcinol bis(2,6-xylyl phosphate). As a commercially available condensed phosphate, there are given, for example, “CR-733S”, “CR-741”, and “PX-200”, which are manufactured by Daihachi Chemical Industry Co., Ltd. One kind of the component (D) may be used alone, or two or more kinds thereof may be used in combination.

The content of the component (D) is 3 mass % or more to 20 mass % or less, preferably 7 mass % or more to 15 mass % or less when the total of the components (A) to (E) is defined as 100 mass %. When the content of the component (D) is 20 mass % or less, the impact strength and heat resistance can be obtained. When the content of the component (D) is 3 mass % or more, the flame retardancy can be obtained.

<(E) Drip Preventing Agent>

As a component (E), a fluorine-based compound may be used. The kind of the fluorine-based compound is not particularly limited, but polytetrafluoroethylene (hereinafter referred to as “PTFE”), a PTFE modified with another resin, or a PTFE-containing mixture is preferred by virtue of good handleability and dispersibility. A specific example thereof is “Metablen A-3800” manufactured by Mitsubishi Rayon Co., Ltd., which is an acrylic-modified PTFE.

The content of the component (E) is 0.1 mass % or more to 5 mass % or less, preferably 0.1 mass % or more to 1 mass % or less when the total of the components (A) to (E) is defined as 100 mass %. When the content of the component (E) is 0.1 mass % or more, a drip preventing effect in conformity to flame retardancy V-1 of UL-94 standard can be obtained. In addition, in consideration of environmental influences, the content of the component (E) preferably falls within such a range that the content of PTFE is 0.5 mass % or less when the total of the components (A) to (E) is defined as 100 mass %.

<Resin Composition>

A resin composition of the present invention has a weight-average molecular weight of preferably 30,000 or more, more preferably 35,000 or more in terms of polystyrene measured by size exclusion chromatography. When the resin composition has a weight-average molecular weight of 30,000 or more in terms of polystyrene sufficient impact strength can be obtained.

The resin composition of the present invention preferably satisfies the following formula (1) because such resin composition can achieve a balance between high flame retardancy and high impact strength.

0.3b+3.5c≦4d (1)

b: content (mass %) of the (B) biomass resin having a hydroxy group
c: content (mass %) of the (C) rubber having a siloxane bond and having a functional group reactive with a hydroxy group
d: content (mass %) of the (D) flame retardant

The resin composition of the present invention may further contain other components such as a pigment, a thermal stabilizer, an antioxidant, an inorganic filler, a weathering agent, a lubricant, an impact resistance improver, a mold releasing agent, an antistatic agent and a resin other than the component (A) and the component (B), as long as the characteristics of the resin composition are not largely impaired. Those components may be added in an amount of 20 parts by mass or less, preferably 5 parts by mass or less, with respect to 100 parts by mass of the resin composition.

In addition, the resin composition of the present invention preferably conforms to V-1 or more of UL-94 standard.

<Production Method>

The resin composition of the present invention may be obtained by melt-kneading the components (A) to (E), and further the other components as required.

In addition, when the flowability of the component (A) and the flowability of the component (B) largely differ from each other in the melt-kneading, it is preferred to add at least part of the component (D) to the component (A) to thereby make the flowability of the component (A) closer to that of the component (B), and then melt-knead the resultant with the component (B). The flowabilities of those resins only need to be at such levels that the component (A) and the component (B) are not separated from each other after their melt-kneading. The separation between the component (A) and the component (B) may be judged from, for example, pearlescent surface appearance. When kneading is sufficiently performed so that the pearlescent surface appearance does not appear, the resin composition can achieve high flame retardancy and impact strength, and excellent surface appearance. The flowability of a resin may be measured with a melt flow rate or the like. For example, it is preferred that the flowability of a resin composition obtained by adding at least part of the component (D) to the component (A) be from 0.01 times to twice as high as the flowability of the component (B), these flowabilities being measured at the same test temperature under the same test load.

A method of producing the resin composition of the present invention preferably includes a first step and a second step. The first step is a step of melt-kneading the component (A) and at least part of the component (D), and further the component (E) in a preferred manner. The second step is a step of melt-kneading a kneaded product obtained in the first step, the component (B) and the component (C) or a step of melt-kneading the kneaded product obtained in the first step, the component (B), the component (C) and the rest of the component (D). The other components may be added in the first step and/or the second step.

A melt-kneading temperature in the first step is preferably from 200° C. to 280° C. When the melt-kneading temperature is 200° C. or more, the materials can be sufficiently kneaded. When the melt-kneading temperature is 280° C. or less, sufficient physical properties are obtained without thermal degradation of the component (A) and the component (D). A melt-kneading temperature in the second step is preferably from 180° C. to 230° C. When the melt-kneading temperature is 180° C. or more, the materials can be sufficiently kneaded. When the melt-kneading temperature is 230° C. or less, sufficient physical properties are obtained without thermal degradation of the component (B).

It is appropriate to perform the first step and the second step of the production method of the present invention with a continuous kneader without cooling the resin composition between the steps. It is also appropriate to cool and pelletize the resin composition obtained after the first step, and then perform the second step through use of the resin composition. For example, in a kneader including a plurality of feeders, the first step is performed on an upstream side of a flow direction of raw materials, and the second step is performed on a downstream side of the flow direction. On the upstream side, the temperature is set to from 200° C. to 280° C. in order to perform the kneading of the first step, and on the downstream side, the temperature is set to from 180° C. to 230° C. in order to perform the second step. On the upstream side, the materials to be used in the first step are pre-dried, and then fed to the kneader with a feeder, followed by melt-kneading. On the downstream side, the materials to be used in the second step after pre-drying are fed with a feeder, followed by melt-kneading with the materials melt-kneaded in the first step. Thus, the resin composition of the present invention can be produced. The materials to be used in the first step and/or the second step may be fed with different feeders or the same feeder. Alternatively, in a kneader including one feeder, the materials to be used in the first step are pre-dried, and then dry-blended with each other, followed by melt-kneading with the kneader at from 200° C. to 280° C. The resin composition after the melt-kneading is pelletized after cooling. The pelletized resin composition is pre-dried, and then dry-blended with the materials to be used in the second step, followed by melt-kneading at from 180° C. to 230° C. Thus, the resin composition of the present invention can be produced.

The production method of the present invention may be performed with a generally used melt-kneader. Specific examples of the melt-kneader include a single-screw extruder, a twin-screw extruder, a kneader, and a Bumbary mixer. Of those, a twin-screw extruder is particularly preferred.

With regard to the mass ratios in the resin composition of the present invention, the ratios in terms of loaded amount may be considered as the compositional ratios in the composition. In addition, the compositional ratios in the composition may also be measured through instrumental analysis of a molded article by NMR or the like.

<Molded Article>

A molded article of the present invention is obtained by molding the resin composition of the present invention. The resin composition of the present invention can be molded into a desired shape. A molding method is not particularly limited, but for example, a known technology, such as extrusion molding or injection molding, may be used.

The molded article of the present invention may be used as a part requiring flame retardancy in an image forming apparatus including a photosensitive member and a housing configured to accommodate the photosensitive member such as a copying machine, a laser beam printer and an inkjet printer. Specific examples of such part include the housing configured to accommodate the photosensitive member, a part around a fixing device, and a part around a power source. In addition, the molded article of the present invention may also be used as an external material when a design property is not affected.

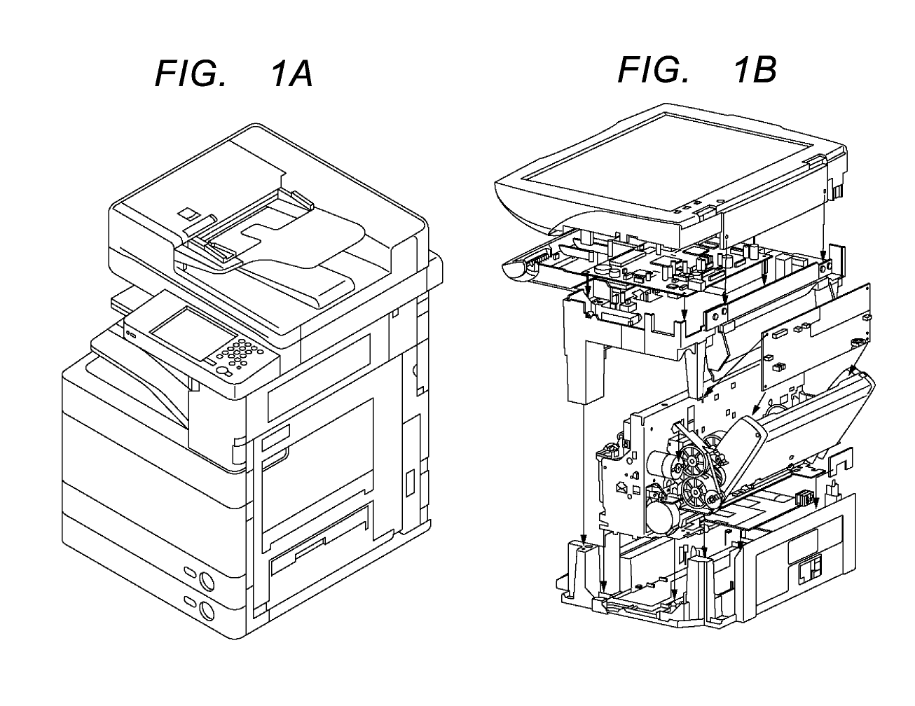

FIG. 1A is an illustration of only external materials, and FIG. 1B is an illustration of the interior including also quasi-external materials. FIG. 1A and FIG. 1B are illustrations of an image forming apparatus, but the present invention is not limited to an embodiment illustrated in FIG. 1A and FIG. 1B.

In addition, the “internal material” refers to a material of a portion which is not seen by a user in use. Examples thereof include, in the image forming apparatus, a plastic part used around a functional part, such as the photosensitive member and a plastic part used around an auxiliary member such as a cable guide or a fan duct.

It is preferred that a material having high heat resistance be used around, in particular, a heating element.

The molded article of the present invention may be used not only for the image forming apparatus but also for a housing of an image pickup apparatus, such as a camera, a housing of a display device, such as a display of a PC, or the like.

### EXAMPLES

Materials used in Examples were as follows.

(A) Polycarbonate Resin:

“GW-1030S” manufactured by Samsung

(B) Biomass Resin Having Hydroxy Group:

Polylactic acid (PLA) “TE-2000” manufactured by Unitika Ltd.

(C) Rubber Having Siloxane Bond and Having Functional Group Reactive with Hydroxy Group:

Glycidyl group-containing silicone/acrylic core-shell rubber “Metablen S-2200” manufactured by Mitsubishi Rayon Co., Ltd.

(C′) Rubber Other than Component (C):

C′-1: silicone/acrylic core-shell rubber “Metablen 5-2006” manufactured by Mitsubishi Rayon Co., Ltd.
C′-2: silicone/acrylic core-shell rubber having a high Si content “Metablen SX-005” manufactured by Mitsubishi Rayon Co., Ltd.
C′-3: MBS-based core-shell rubber “Metablen C-223A” manufactured by Mitsubishi Rayon Co., Ltd.

(D) Flame Retardant:

Condensed phosphate-based flame retardant “PX-200” manufactured by Daihachi Chemical Industry Co., Ltd.

(E) Drip Preventing Agent:

Acrylic resin-modified PTFE “Metablen A-3800” manufactured by Mitsubishi Rayon Co., Ltd. PTFE content: 50 mass %

### Example 1

The component (A) was dried at 100° C. for 6 hours, and the component (B) was dried at 80° C. for 6 hours.

[First Step]

863.5 g of the component (A), 130 g of the component (D), and 6.5 g of the component (E) were weighed, and then dry-blended with each other. After that, the resultant was melt-kneaded with a twin-screw extruder (Laboplasto mill manufactured by Toyo Seiki Seisaku-sho, Ltd.) at a cylinder temperature of from 240° C. to 250° C. A resin discharged from the tip of the extruder was cut into a pellet shape. Thus, pellets of the resin were obtained. The obtained pellets were dried at 80° C. for 6 hours.

[Second Step]

770 g of the resin composition produced in the first step, 200 g of the component (B), and 30 g of the component (C) were weighed, and then dry-blended with each other. After that, the resultant was melt-kneaded with the same twin-screw extruder as in the first step at a cylinder temperature of from 210° C. to 220° C. A resin discharged from the tip of the extruder was cut into a pellet shape. Thus, pellets of the resin were obtained.

The compositional ratios in the resin composition (ratios in terms of loaded amount) are shown in Table 1. In Table 1, the case where the formula (1) was satisfied was represented by the symbol “∘”, and the case where the formula (1) was not satisfied was represented by the symbol “x”.

[Molding]

Next, the resin composition produced in the second step was dried at 80° C. for 6 hours, and then a multipurpose test piece (80 mm×10 mm×t (thickness) 4 mm) and a test piece for a flame retardancy test (125 mm×13 mm×t 1.5 mm) were molded therefrom with an injection molding machine (SE18DU manufactured by Sumitomo Heavy Industries, Ltd.) at a cylinder temperature of from 240° C. to 250° C. and a mold temperature of 40° C.

[Evaluation]

The molded test pieces were evaluated as described below. The results are shown in Table 1.

(1) Flame Retardancy

Test method: V test in conformity to UL-94 standard (125 mm vertical burning test)
Sample shape: test piece for flame retardancy test

(2) Charpy Impact Strength

Test method: in conformity to JIS K 7111
Sample shape: multipurpose test piece
Notch processing: NOTCHING TOOL A-3 (manufactured by Toyo Seiki Seisaku-sho, Ltd.) was used. Type A notch.
Measurement apparatus: Digital Impact Tester DG-UB (manufactured by Toyo Seiki Seisaku-sho, Ltd.)

(3) Weight-Average Molecular Weight

Test method: in conformity to JIS K 0124
Measurement apparatus: Alliance 2695 (manufactured by Waters Corporation)
Detector: PDA Detector 2996 (manufactured by Waters Corporation)
Mobile phase: tetrahydrofuran
Flow rate: 1.0 mL/min
Columns: LF-G and LF-804 (manufactured by Showa Denko K.K.)
Column temperature: 40° C.
Standard substance: Polystyrene (manufactured by Polymer Laboratories Ltd.)

(4) Outer Appearance

The surface of the test piece was evaluated for the presence or absence of pearlescence through visual observation. The case where pearlescence was absent was represented by the symbol “∘”, and the case where pearlescence was present was represented by the symbol “x”.

### Examples 2 to 7 and Comparative Examples 1 to 10

Resin compositions were produced and evaluated in the same manner as in Example 1 except that the compositional ratios in each resin composition (ratios in terms of loaded amount) were changed as shown in Tables 1 and 2. The component (C′) was used in the second step together with the component (C) or instead of the component (C).

TABLE 1

| | | | Example 1 | Example 2 | Example 3 | Example 4 | Example 5 | Example 6 | Example 7 |
|---|---|---|---|---|---|---|---|---|---|
| Composition | Component (A) | | 66.5 | 65.5 | 64.5 | 62.5 | 59.5 | 64.5 | 62.5 |
| | (mass %) | | | | | | | | |
| | Component (B) | | 20 | 20 | 20 | 20 | 20 | 20 | 22 |
| | (mass %) | | | | | | | | |
| | Component (C) | | 3 | 4 | 5 | 5 | 5 | 2.5 | 5 |
| | (mass %) | | | | | | | | |
| | Component | C′-1 | 0 | 0 | 0 | 0 | 0 | 0 | 0 |
| | (C′) | C′-2 | 0 | 0 | 0 | 0 | 0 | 0 | 0 |
| | (mass %) | C′-3 | 0 | 0 | 0 | 0 | 0 | 2.5 | 0 |

| | | | | | | | | |
|---|---|---|---|---|---|---|---|---|
| | Component (D) | 10 | 10 | 10 | 12 | 15 | 10 | 10 |
| | (mass %) | | | | | | | |
| | Component (E) | 0.5 | 0.5 | 0.5 | 0.5 | 0.5 | 0.5 | 0.5 |
| | (mass %) | | | | | | | |
| | (B)/(A) (mass | 0.30 | 0.31 | 0.31 | 0.32 | 0.34 | 0.31 | 0.35 |
| | ratio) | | | | | | | |
| | Formula (1) | ∘ | ∘ | ∘ | ∘ | ∘ | ∘ | ∘ |
| Evaluation | Weight-average | 37,000 | 37,000 | 37,000 | 37,000 | 37,000 | 37,000 | 37,000 |
| | molecular | | | | | | | |
| | weight | | | | | | | |
| | Flame | Corre- | Corre- | Corre- | Corre- | Corre- | Corre- | Corre- |
| | retardancy | sponding | sponding | sponding | sponding | sponding | sponding | sponding |
| | | to V-1 | to V-1 | to V-1 | to V-1 | to V-1 | to V-1 | to V-1 |
| | Charpy impact | 18 | 22 | 48 | 22 | 20 | 22 | 17 |
| | strength | | | | | | | |
| | (kJ/m²) | | | | | | | |
| | Outer | ∘ | ∘ | ∘ | ∘ | ∘ | ∘ | ∘ |
| | appearance | | | | | | | |

TABLE 2

| | | | Com- | Com- | Com- | Com- | Com- | Com- | Com- | Com- | Com- | Com- |
|---|---|---|---|---|---|---|---|---|---|---|---|---|
| | | | para- | para- | para- | para- | para- | para- | para- | para- | para- | para- |
| | | | tive | tive | tive | tive | tive | tive | tive | tive | tive | tive |
| | | | Example | Example | Example | Example | Example | Example | Example | Example | Example | Example |
| | | | 1 | 2 | 3 | 4 | 5 | 6 | 7 | 8 | 9 | 10 |
| Composition | Component | | 59.5 | 64.5 | 64.5 | 64.5 | 54.5 | 49.5 | 68.5 | 54.5 | 54.5 | 61 |
| | (A) (mass %) | | | | | | | | | | | |
| | Component | | 20 | 20 | 20 | 20 | 30 | 30 | 25 | 20 | 20 | 22 |
| | (B) (mass %) | | | | | | | | | | | |
| | Component | | 10 | 0 | 0 | 0 | 5 | 0 | 1 | 5 | 7 | 5 |
| | (C) (mass %) | | | | | | | | | | | |
| | Component | C′-1 | 0 | 5 | 0 | 0 | 0 | 0 | 0 | 0 | 0 | 0 |
| | (C′) | C′-2 | 0 | 0 | 5 | 0 | 0 | 0 | 0 | 0 | 0 | 0 |
| | (mass %) | C′-3 | 0 | 0 | 0 | 5 | 0 | 5 | 0 | 0 | 0 | 0 |

| | | | | | | | | | | | |
|---|---|---|---|---|---|---|---|---|---|---|---|
| | Component | 10 | 10 | 10 | 10 | 10 | 15 | 5 | 20 | 18 | 12 |
| | (D) (mass %) | | | | | | | | | | |
| | Component | 0.5 | 0.5 | 0.5 | 0.5 | 0.5 | 0.5 | 0.5 | 0.5 | 0.5 | 0.5 |
| | (E) (mass %) | | | | | | | | | | |
| | (B)/(A) | 0.34 | 0.31 | 0.31 | 0.31 | 0.55 | 0.61 | 0.36 | 0.37 | 0.37 | 0.36 |
| | (mass ratio) | | | | | | | | | | |
| | Formula (1) | x | ∘ | ∘ | ∘ | ∘ | ∘ | ∘ | ∘ | ∘ | ∘ |
| Evaluation | Weight- | 37,000 | 37,000 | 37,000 | 37,000 | 37,000 | 37,000 | 37,000 | 37,000 | 37,000 | 37,000 |
| | average | | | | | | | | | | |
| | molecular | | | | | | | | | | |
| | weight | | | | | | | | | | |
| | Flame | Not | Not | Not | Corre- | Not | Not | Not | Corre- | Corre- | Corre- |
| | retardancy | passed | passed | passed | sponding | passed | passed | passed | sponding | sponding | sponding |
| | | | | | to V-2 | | | | to V-0 | to V-1 | to V-1 |
| | Charpy | 63 | 20 | 16 | 18 | 18 | 10 | 12 | 7 | 13 | 14 |
| | impact | | | | | | | | | | |
| | strength | | | | | | | | | | |
| | (kJ/m²) | | | | | | | | | | |
| | Outer | ∘ | ∘ | ∘ | ∘ | ∘ | ∘ | ∘ | ∘ | ∘ | ∘ |
| | appearance | | | | | | | | | | |

As apparent from Tables 1 and 2, the results of the compositions of Examples were that the required flame retardancy V-1 was satisfied and the Charpy impact strength was 15 kJ/m² or more. On the other hand, the results of the compositions of Comparative Examples were that the required flame retardancy V-1 and the required Charpy impact strength of 15 kJ/m² were not balanced.

### Advantageous Effects of Invention

The resin composition of the present invention has high flame retardancy and impact strength, and excellent surface appearance while containing the polycarbonate resin and the biomass resin. Therefore, the resin composition of the present invention may be used as a molding material for an office machine, an electrical and electronic part, an automobile part, a construction member, or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-090475, filed Apr. 27, 2015, which is hereby incorporated by reference herein in its entirety.

1. A resin composition comprising:
a polycarbonate resin;
a biomass resin having a hydroxy group;
a rubber having a siloxane bond and having a functional group reactive with a hydroxy group;
a flame retardant; and
a drip preventing agent,
wherein when a total content of all components in the resin composition is 100 mass %:
a content of the biomass resin is 5 mass % to 25 mass %,
a content of the rubber is 1 mass % to 9 mass %,
a content of the flame retardant is 3 mass % to 20 mass %, and
a content of the drip preventing agent is 0.1 mass % to 5 mass %, and
wherein a mass ratio of the biomass resin to the polycarbonate resin is 0.35 or less.

2. The resin composition according to claim 1, wherein the resin composition has a weight-average molecular weight of 30,000 or more in terms of polystyrene measured by size exclusion chromatography.

3. The resin composition according to claim 1, wherein the resin composition satisfies formula (1):
0.3b+3.5c≦4d (1),
where:
b represents the content of the biomass resin;
c represents the content of the rubber; and
d represents the content of the flame retardant.

4. The resin composition according to claim 1, wherein:
the polycarbonate resin comprises a regenerated polycarbonate resin comprising a recovered polycarbonate resin; and
the regenerated polycarbonate resin has a weight-average molecular weight of 30,000 or more in terms of polystyrene measured by size exclusion chromatography.

5. The resin composition according to claim 1, wherein the biomass resin comprises polylactic acid.

6. The resin composition according to claim 1, wherein the rubber has a glycidyl group as the functional group reactive with the hydroxy group.

7. The resin composition according to claim 1, wherein the flame retardant comprises a phosphorus-based flame retardant.

8. The resin composition according to claim 1, wherein the drip preventing agent comprises a fluorine-based compound.

9. The resin composition according to claim 1, wherein the resin composition conforms to V-1 or more of UL-94 standard.

10. A molded article, which is obtained by molding the resin composition of claim 1.

11. An image forming apparatus comprising:
a photosensitive member; and
a housing configured to accommodate the photosensitive member,
wherein the housing comprises the molded article of claim 10.

12. A method of producing the resin composition of claim 1, the method comprising:
a first step of melt-kneading the polycarbonate resin and at least part of the flame retardant; and
a second step of melt-kneading:
a kneaded product obtained in the first step, the biomass resin, and the rubber; or
the kneaded product obtained in the first step, the biomass resin, the rubber, and a rest of the flame retardant.

13. The method of producing the resin composition according to claim 12, wherein the first step comprises a step of melt-kneading the polycarbonate resin, the at least part of the flame retardant, and the drip preventing agent.

14. A method of producing a molded article, the method comprising subjecting the resin composition of claim 1 to one of extrusion molding and injection molding.
